(19) United States
(12) Patent Application Publication
(10) Pub. No.: US 2004/0086326 A1
(43) Pub. Date: May 6, 2004

(54) Connecting element for mounting an electric motor

(76) Inventors: Ingolf Groening, Lohr (DE); Bernd Schnurr, Lohr (DE)

Correspondence Address: STRIKER, STRIKER & STENBY, 103 East Neck Road, Huntington, NY, 11743, US

(21) Appl. No.: 10/656,362

(22) Filed: Sep. 5, 2003

(30) Foreign Application Priority Data
Sep. 7, 2002 (DE) 102 41 515.3

(51) Int. Cl. F16B 7/08

(52) U.S. Cl. 403/187

(57) ABSTRACT

A connection element composed of metal and provided for a releasable connection of an electric motor with a machine or a machine part which is driven by the electric motor, has least one first abutment surface mountable on a wall of the machine or the machine part, and at least one second abutment surface fixedly connectable with the electric motor, at least one of the at least one first abutment surface and the second abutment surface being provided with a thin metallic coating with a thermal conductivity having a value smaller than approximately 2 W/Km (Watt×Kelvin⁻¹×Meter⁻¹).

### BACKGROUND OF THE INVENTION

The present invention relates to a connecting element for mounting an electric motor on a machine or a machine part.

The electric motors for driving machines and machine parts generate relatively high temperatures during the operation under high stresses. Since between the electric motor and the machine mainly a form-locking and/or form-transmitting connection is provided, the heat of the electric motor is transferred to the machine. In the case of temperature-sensitive machines or machine parts, a thermal insulation or a withdrawal of heat generated from the electric motor must be guaranteed. This can be performed for example by a fluid cooling, by means of circulation of a cooling fluid in a connecting element. The connecting element in this case is connected on one side with the machine or the machine part and is connected on the other side with the electric motor, for example by screws, and therefore thermal insulation of machine from the motor is required.

### SUMMARY OF THE INVENTION

Accordingly, it is an object of the present invention to provide a connecting element for mounting of an electric motor, which avoids the disadvantages of the prior art.

More particularly, it is an object of the present invention to provide a connecting element for mounting of an electric motor, which guarantees a good thermal insulation of machines or machine parts from a motor which is connected to it.

In keeping with these objects and with others which will become apparent hereinafter, one feature of the present invention resides, briefly stated, in a connecting element for mounting an electric motor which has a connection element composed of metal and provided for a releasable connection of an electric motor with a machine or a machine part which is driven by the electric motor, the connecting element having at least one first abutment surface mountable on a wall of the machine or the machine part, and at least one second abutment surface fixedly connected with the electric motor, at least one of said at least one first abutment surface and said at least one second abutment surface being provided with a thin metallic coating with a thermal conductivity having a value smaller than approximately 2 W/Km (Watt×Kelvin⁻¹×Meter⁻¹).

It can be seen that a connecting element composed of metal for releasable mounting of an electric motor on a machine driven by the electric motor on a machine part driven by the electric motor, has at least one first abutment surface mountable on a wall of the machine or the machine part and at least one second abutment surface fixedly connectable with the electric motor. In accordance with the invention, the at least one first abutment surface and/or the at least one second abutment surface has a thin metallic coating with a thermal conductivity over values smaller than approximately 2 Watt/Kelvin.Meter (W/Km)

Such a metallic coating is used for minimization of the heat transfer from the electric motor to the machine. With the improvement of the thermal insulation, the motor can operate with higher loads and can generate higher heat without problems. With the same dimensions of the electric motor, a higher power and a higher torque is permissible. Such a thin metallic coating is identified as a so-called hard-coat and applied first of all on inner walls of cooling pipes or cooling conduits, to guarantee a corrosion protection. In particular aluminum or cast iron have a tendency for corrosion in the case of long continuing contact with a cooling fluid.

A suitable material for the thin metallic coating is for example nitrated titanium (TiN). A titanium nitrate adheres especially well to iron-containing base material and has a high wear resistance. A further increase of the resistance properties can be obtained with a metallic coating of nitrated titanium with added carbon (TiCN).

In an alternative embodiment of the invention resides the thin metallic coating has a nitrated alloy of titanium and aluminum (TiAlN). This material has, in addition to high mechanical properties, also a high oxidation resistance and provides a good resistance against aggressive media of all types.

In accordance with a further alternative embodiment of the invention, the coating has a chromium mixed with carbon (CrC). This coating material has, in addition to its very good mechanical properties, in particular a high temperature resistance. A metallic coating from nitrated chromium (CrN) has a high resistance against corrosion and oxidation. Alternatively, the coating can be composed of tungsten carbide (WC), when low friction coefficients are desired.

The thin metallic coating has preferably a thickness between less than 1 μm and up to 10 μm. With this layer thickness a good thermal insulation is guaranteed and nevertheless the electrical properties of the metallic connecting elements are maintained, which can be required for example for a ground connection between the motor and the machine. Possible electrical function of the housing as a protection conductor is not negatively affected.

The mounting element can be provided on the first abutment surface with blind holes with inner threads for screw mounting of the connecting element on the machine or on the machine part. This inner thread or these inner threads of the first abutment surface are provided for example also with a metallic coating. In this way, an optimal heat damping of the machine against the heat loss of the electric motor is guaranteed.

The mounting element, in addition, can be provided on the second abutment surface with throughgoing openings for screw mounting of the electric motor on the connecting element. Preferably, these throughgoing openings are provided also with a thin metallic coating for a thermal insulation.

In accordance with a further embodiment of the invention, the mounting element has integrated cooling conduits for circulation of a cooling fluid. This cooling fluid serves for a fast withdrawal of the heat loss from the electric motor and/or for a thermal constant in direction to the machine. A further advantage of the hard-coat of the contact points between the machine and the motor is the improvement of roughness depth. Therefore, during mounting of the motor lower friction occurs.

Summarizing the above, the following aspects of the invention should be highlighted. As a rule the motors have linear abutment or punctual/circular abutment with respect to the machine, on which they are screwed. Instead a flat abutment is provided. Through the linear abutment/punctual/circular/flat abutment and the screwing, the heat generated in the motor is transferred to the machine. The heat conductivity value during this heat transfer lies typically within the region of 500-1000W/Km. With the application of the hard coat on the surfaces which have the contact with the parts connected to the heat conductivity of the machine, the heat transfer to these points is drastically reduced. The typical heat conductivity of a hard coat amounts to approximately 0.5-1.2 W/Km. Since the hard coat is connected with the base material, the same tensile stresses are possible as before.

Since the application thickness of the hard coat is small because it is applied for example in a fluid bath, the hard coat can be applied also in the threaded openings. Thereby a further improvement of the heat thermal insulating action is achieved.

Since the specific resistance of the material coated with the hard coat is greater only by the factor 10 when compared with the non-coated materials (mainly aluminum), the hard coat also acts as an electrical conductor. Therefore, in the event of failure, a protective function as a protective conductor is not limited with the use of the hard coat.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a cross-section of a connecting element in accordance with the present invention;

FIG. 2 is a view showing a schematic section of the connecting element connected with the machine and the electric motor in accordance with the present invention.

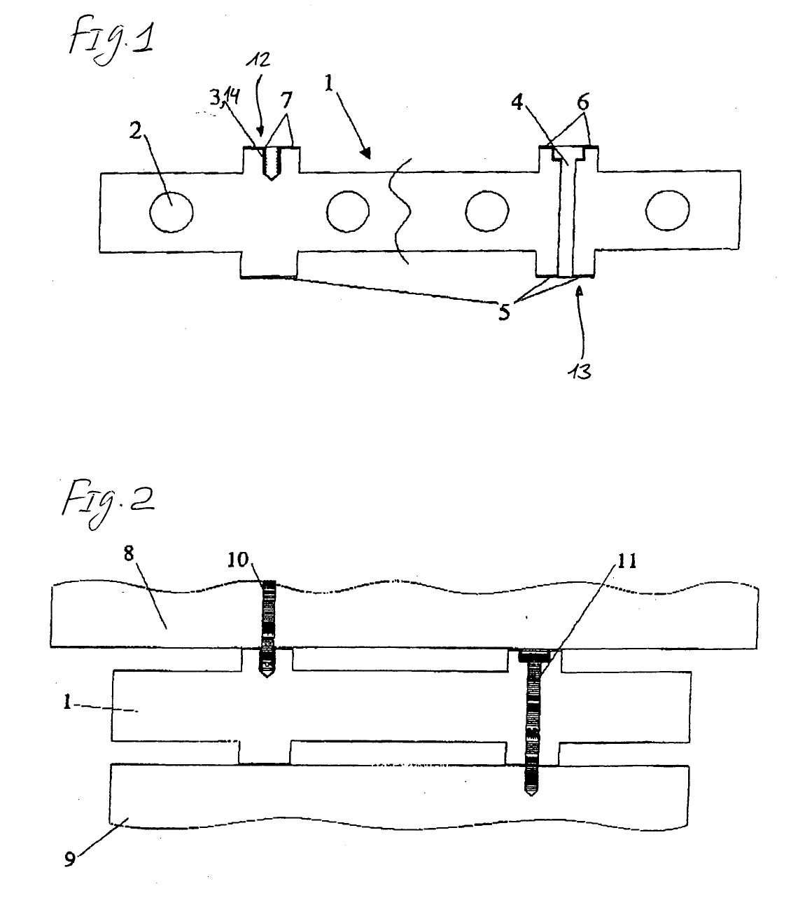

### DESCRIPTION OF THE PREFERRED EMBODIMENTS

FIG. 5 shows a connecting element 1 in accordance with the present invention. It has an elongated and/or a plate-shaped contour with a row of bases for mounting of the connecting element on a machine or for connection with an electric motor. A first abutment surface 12 for screw connection of the connecting element with a machine 8 can be seen at the left side of the connecting element 1. The connecting element 1 can be connected with the machine 8 by screws 10, as shown in FIG. 2. For this purpose a corresponding screw 10 is screwed from the machine 8 into the blind hole 3 with an inner thread 14 of the first abutment surface 13.

The connecting element further has a second abutment surface 13 which is provided with a throughgoing opening 4 in its center. The throughgoing opening 4 serves for mounting of an electric motor 9 on the connecting element 1. For this purpose the screw 11 extended through the throughgoing opening 4 and is screwed with the electric motor 9. At least the first abutment surfaces 13 and the second abutment surfaces 13 are provided with a coating 5, 6 and 7.

The coating is composed of a corresponding material, for example TiCN, TiAlN, CrC, CrN, WC. It has a thickness between 1 and 10 μm. It provides a very low heat conductivity value between the connecting element and the electric motor or the connecting element and the machine. This heat conductivity value is located within the range of 2W/K.m. Thereby a very efficient thermal insulation between the motor and the machine is obtained.

The connecting element 1 can be provided optionally with cooling conduits 2 for circulation of a cooling fluid. They can be provided on their walls in some cases with a metallic coating for preventing corrosion. Furthermore, the inner thread 14 of the blind holes 3 and/or the inner walls of the throughgoing openings 4 can be provided with a very thin metallic coating from one of the above mentioned materials. In this way a further improvement of the insulation of the machine from the heat losses of the electric motor is provided.

It will be understood that each of the elements described above, or two or more together, may also find a useful application in other types of constructions differing from the types described above.

While the invention has been illustrated and described as embodied in connecting element for mounting an electric motor, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A connection element composed of metal and provided for a releasable connection of an electric motor with a machine or a machine part which is driven by the electric motor, the connecting element comprising at least one first abutment surface mountable on a wall of the machine or the machine part, and at least one second abutment surface fixedly connected with the electric motor, at least one of said at least one first abutment surface and said at least one second abutment surface being provided with a thin metallic coating with a thermal conductivity having a value smaller than approximately 2 W/Km (Watt×Kelvin⁻¹×Meter⁻¹).

2. A connection element as defined in claim 1, wherein said thin metallic coating has a nitrated titanium.

3. A connection element as defined in claim 1, wherein said thin connecting coating has a nitrated titanium mixed with carbon.

4. A connection element as defined in claim 1, wherein said thin metallic coating has a nitrated alloy of titanium and aluminum.

5. A connection element as defined in claim 1, wherein said thin metallic coating has a chromium mixed with carbon.

6. A connection element as defined in claim 1, wherein said thin metallic coating has nitrated chromium.

7. A connection element as defined in claim 1, wherein said thin metallic coating has tungsten carbide.

8. A connection element as defined in claim 1, wherein said thin metallic coating has tungsten mixed with carbon.

9. A connection element as defined in claim 1, wherein said thin metallic coating has a thickness between less than 1 μm and 10 μm.

10. A connection element as defined in claim 1, wherein said first abutment surface is provided with a blind hole with an inner thread for screwing connection of the connecting element on the machine or on the machine part.

11. A connection element as defined in claim 10, wherein said inner thread of said first abutment surface is provided with the thin metallic coating.

12. A connection element as defined in claim 1, wherein said second abutment surface is provided with a throughgoing opening for screw connection of the electric motor with the connecting element.

13. A connection element as defined in claim 12, wherein said throughgoing opening is provided with the thin metallic coating.

14. A connection element as defined in claim 1; and further comprising integrated cooling conduits for circulation of cooling fluid.
